(19) United States
(12) Patent Application Publication
(10) Pub. No.: US 2005/0217372 A1
(43) Pub. Date: Oct. 6, 2005

(54) Physical quantity sensor having angular speed sensor and acceleration sensor

(75) Inventor: Kenichi Ao, Tokai-city (JP)

Correspondence Address: POSZ LAW GROUP, PLC, 12040 SOUTH LAKES DRIVE, SUITE 101, RESTON, VA, 20191, US

(73) Assignee: DENSO CORPORATION

(21) Appl. No.: 11/081,604

(22) Filed: Mar. 17, 2005

(30) Foreign Application Priority Data
Mar. 30, 2004 (JP) 2004-99799

(51) Int. Cl. G01P 15/08

(52) U.S. Cl. 73/488

(57) ABSTRACT

A physical quantity sensor includes: a substrate; three angular speed sensors disposed on the substrate; and three acceleration sensors disposed on the substrate. The three angular speed sensors are capable of detecting three components of an angular speed around three axes, each two of which intersect perpendicularly. The three acceleration sensors are capable of detecting three components of an acceleration in another three axes, each two of which intersect perpendicularly. The three axes of the angular speed sensors intersect at one point, and the other three axes of the acceleration sensors intersect at another one point.

### CROSS REFERENCE TO RELATED APPLICATION

This application is based on Japanese Patent Application No. 2004-99799 filed on Mar. 30, 2004, the disclosure of which is incorporated herein by reference.

### FIELD OF THE INVENTION

The present invention relates to a physical quantity sensor having an angular speed sensor and an acceleration sensor.

### BACKGROUND OF THE INVENTION

An angular speed sensor and an acceleration sensor are suitably used for an automotive vehicle. The angular seed sensor and the acceleration sensor work for controlling an attitude of the vehicle and the like. These angular speed sensor and acceleration sensor are mounted on one base member such as a chip or a substrate so that a physical quantity sensor is formed. This type of the physical quantity sensor is disclosed in, for example, U.S. Patent Application Publication No. 2002-0051258-A1 or Japanese Patent Application Publication No. H10-10148.

It is required to detect an acceleration and an angular speed three dimensionally for controlling the vehicle attitude accurately. Specifically, the acceleration is detected by dividing three compositions of a X axis, a Y axis and a Z axis, and the angular speed is also detected by dividing three compositions of the X axis, the Y axis and the Z axis.

However, the conventional sensor disclosed in JP-H10-10148 can only detect the angular speed around the X axis and the Y axis and the acceleration around the Z axis. The sensor disclosed in No. 2002-0051258-A1 can only detect the angular speed around the Z axis and the acceleration around the Y axis. Therefore, the conventional sensor having both of the angular seed sensor and the acceleration sensor can not detect the angular speed and the acceleration three dimensionally with high accuracy.

### SUMMARY OF THE INVENTION

In view of the above-described problem, it is an object of the present invention to provide a physical quantity sensor for detecting an angular speed and an acceleration three dimensionally with high accuracy.

A physical quantity sensor includes: a substrate; three angular speed sensors disposed on the substrate; and three acceleration sensors disposed on the substrate. The three angular speed sensors are capable of detecting three components of an angular speed around three axes, each two of which intersect perpendicularly. The three acceleration sensors are capable of detecting three components of an acceleration in another three axes, each two of which intersect perpendicularly. The three axes of the angular speed sensors intersect at one point, and the other three axes of the acceleration sensors intersect at another one point.

The above physical quantity sensor can detect both of the angular speed and the acceleration three dimensionally with high accuracy. Further, in the physical quantity sensor, three detection axes of the angular speed sensors intersect at one point so that the detection accuracy of the angular speed becomes higher. Further, three detection axes of the acceleration sensors intersect at one point so that the detection accuracy of the acceleration becomes higher. Thus, the total detection accuracy of both of the angular speed and the acceleration is improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a plan view showing a physical quantity sensor according to a first embodiment of the present invention;

FIG. 2 is a plan view showing an angular speed sensor in the physical quantity sensor according to the first embodiment;

FIG. 3 is a plan view showing an acceleration sensor in the physical quantity sensor according to the first embodiment;

FIG. 4 is a plan view showing a physical quantity sensor according to a second embodiment of the present invention; and

FIG. 5 is a cross sectional view showing the physical quantity sensor taken along line V-V in FIG. 4.

### DETAILED DESCRIPTION OF THE PREFERRED EMBODIMENTS

(First Embodiment)

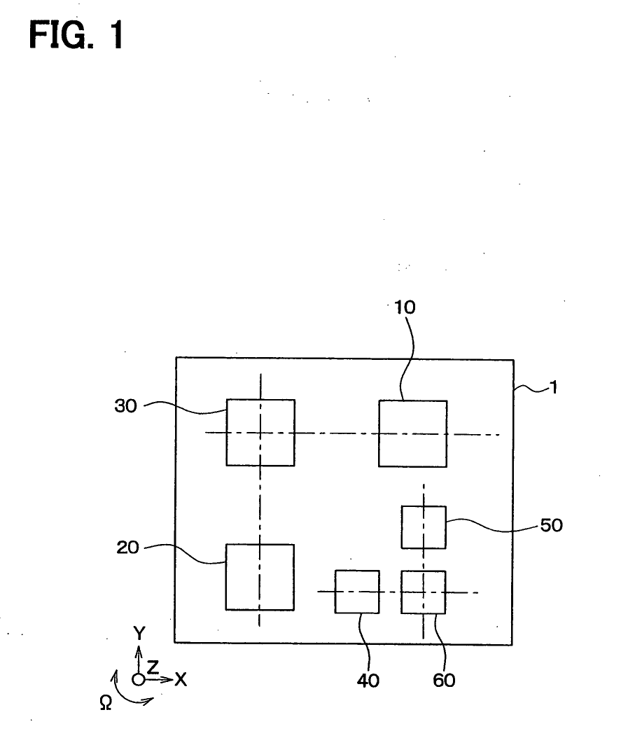

A physical quantity sensor having an acceleration sensor and an angular speed sensor according to a first embodiment of the present invention is shown in FIGS. 1 to 3. The physical quantity sensor includes three angular speed sensors 10, 20, 30 and three acceleration sensors 40, 50, 60, which are mounted on one mounting base 1. The mounting base 1 is composed of a circuit chip, a substrate and the like. Three compositions of an acceleration around three axes are detected by the acceleration sensors 40, 50, 60, and three compositions of an angular speed around three axes are detected by the angular speed sensors 10, 20, 30. Thus, the physical quantity sensor can detect both of the acceleration and the angular speed three dimensionally. The angular speed sensors 10, 20, 30 and the acceleration sensors 40, 50, 60 are bonded to the mounting base 1 with an adhesive.

Three angular speed sensors 10, 20, 30 are disposed on the X axis, the Y axis and the Z axis, respectively. Here, the X axis, the Y axis and the Z axis are at 90 degree angles together, and intersect at one point (i.e., an original point). The first angular speed sensor 10 detects the X composition of the angular speed around the X axis, the second angular speed sensor 20 detects the Y composition of the angular speed around the Y axis, and the third angular speed sensor 30 detects the Z composition of the angular speed around the Z axis.

Three acceleration sensors 40, 50, 60 are disposed on another X axis, another Y axis and another Z axis, respectively. Here, the other X axis, the other Y axis and the other Z axis are at 90 degree angles together, and intersect at another one point (i.e., another original point). The other three axes of the acceleration sensors 40, 50, 60 are not always the same axes as those of the angular speed sensors 10, 20, 30. However, preferably, the X axis concerning the first angular speed sensor 10 is parallel to the other X axis concerning the first acceleration sensor 40, the Y axis concerning the second angular speed sensor 20 is parallel to the other Y axis concerning the second acceleration sensor 50, and the Z axis concerning the third angular speed sensor 30 is parallel to the other Z axis concerning the third acceleration sensor 60. The first acceleration sensor 40 detects the X composition of the acceleration around the X axis, the second acceleration sensor 50 detects the Y composition of the acceleration around the Y axis, and the third acceleration sensor 60 detects the Z composition of the acceleration around the Z axis.

Each angular speed sensor 10, 20, 30 has the same construction; and therefore, only the third angular speed sensor 30 for detecting the Z composition of the angular speed around the Z axis is described in detail as follows. The first and the second angular speed sensors 10, 20 have the same description as the third angular speed sensor 30. Similarly, each acceleration sensor 40, 50, 60 has the same construction; and therefore, only the second acceleration sensor 50 for detecting the Y composition of the acceleration around the Y axis is described in detail as follows. The first and the third acceleration sensors 40, 60 have the same description as the second acceleration sensor 50.

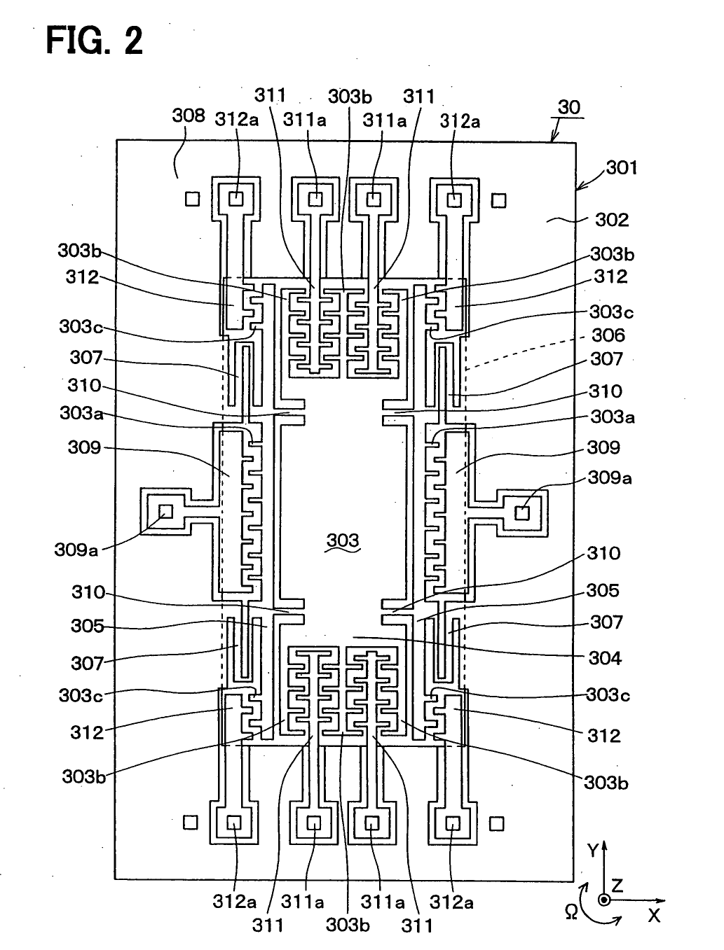

Firstly, the third angular speed sensor 30 is described with reference to FIG. 2. The third angular speed sensor 30 is formed on a SOI (i.e., silicon on insulator) substrate 301. The SOI substrate 301 is composed of a pair of silicon layers and an insulation film. The silicon layers are bonded each other with the insulation film such as an oxide film. The third angular speed sensor 30 is formed by a conventional semiconductor process.

FIG. 2 shows an upper silicon layer 302 in the SOI substrate 301. The upper silicon layer 302 is processed by a conventional etching method so that grooves are formed and parts are also formed. A movable portion as an oscillator 303 is formed on a concavity 306, which is formed by removing part of the insulation film and a lower silicon layer. The upper silicon layer 302 is supported by the insulation film and the lower silicon layer as the other silicon layer. The movable portion 303 includes the first movable portion 304 disposed on a center portion of the silicon layer 302 and the second movable portion 305 disposed on both sides of the first movable portion 304 in the x direction.

The movable portion 303 is supported on a support portion 308 through a driving beam 307 as the first spring and a detection beam 310 as the second spring. The driving beam 307 has a spring function in the X direction for being movable in the X direction, and the detection beam 310 -has a spring function in the Y direction for being movable in the Y direction. The support portion 308 is disposed outside of the movable portion 303. Thus, the movable portion 303 is movable in the X direction and the Y direction, which is perpendicular to the X direction, so that the movable portion 303 is capable of oscillating in both directions. A periphery of the movable portion 303 and a part of the support portion 308 in the upper silicon layer 302 have comb-teeth electrodes having comb-teeth, respectively. The part of the support portion 308 faces the periphery of the movable portion 303. Specifically, a driving electrode 309 as a comb-teeth electrode is formed in the part of the support portion 308. The driving electrode 309 applies a driving signal as an electric potential to the movable portion 303 as the oscillator to drive and to oscillate the movable portion 303 in the X direction. A detection electrode 311 as another comb-teeth electrode is formed in another part of the support portion 308. The detection electrode 311 detects an oscillation of the movable portion 303 in the Y direction as a detection signal, in a case where the oscillation is generated when an angular speed Ω around the Z axis perpendicular to the X and Y axes is applied to the third angular speed sensor 30.

A monitor electrode 312 having a comb-teeth shape is formed outside of the second movable portion 305 in the X direction. The monitor electrode 312 is provided by the upper silicon layer 302. The monitor electrode 312 is supported on a periphery of the concavity 306. In this embodiment, four monitor electrodes 312 are formed in the third angular speed sensor 30. The monitor electrode 312 monitors (i.e., detects) the driving oscillation of the movable portion 303 in the X direction, and then, detects a monitor signal corresponding to the driving oscillation. Each electrode 309, 311, 312 has an electrode pad 309a, 311a, 312a for wire bonding.

The movable portion 303 includes comb-teeth portions 303a, 303b, 303c, which correspond to the electrodes 309, 311, 312. The first comb-teeth portion 303a having comb-teeth faces the driving electrode 309, the second comb-teeth portion 303b faces the detection electrode 311, and the third comb-teeth portion 303c faces the monitor electrode 312 in such a manner that comb-teeth of each of the electrodes 309, 311, 312 and the portions 303a to 303c engages together.

An alternative driving signal, i.e., an alternative electric voltage having a frequency equal to a resonant frequency of the movable portion 303 in the X direction is applied between the driving electrode 309 and the first comb-teeth electrode 303a of the movable portion 303. The first comb-teeth electrode 303a is used for oscillating the movable portion 303, and therefore, the first comb-teeth portion 303a works as a driving comb-teeth portion. Thus, the movable portion 303 is oscillated in the X direction through the driving beam 307. In a case where the angular speed Ω is applied to the third angular speed sensor 30 when the movable portion 303 is oscillated, a Coriolis force is generated in the movable portion 303 in the Y direction so that the movable portion 303 is oscillated in the Y direction through the detection beam 310. This oscillation as a detection oscillation causes to change an electric capacitance of a capacitor between the detection electrode 311 and the second comb-teeth portion 303b of the movable portion 303. Thus, the second comb-teeth portion 303b works as a detection comb-teeth portion. Therefore, by detecting the capacitance change of the capacitor between the detection electrode 311 and the second comb-teeth portion 303b, the angular speed Ω around the Z axis is obtained.

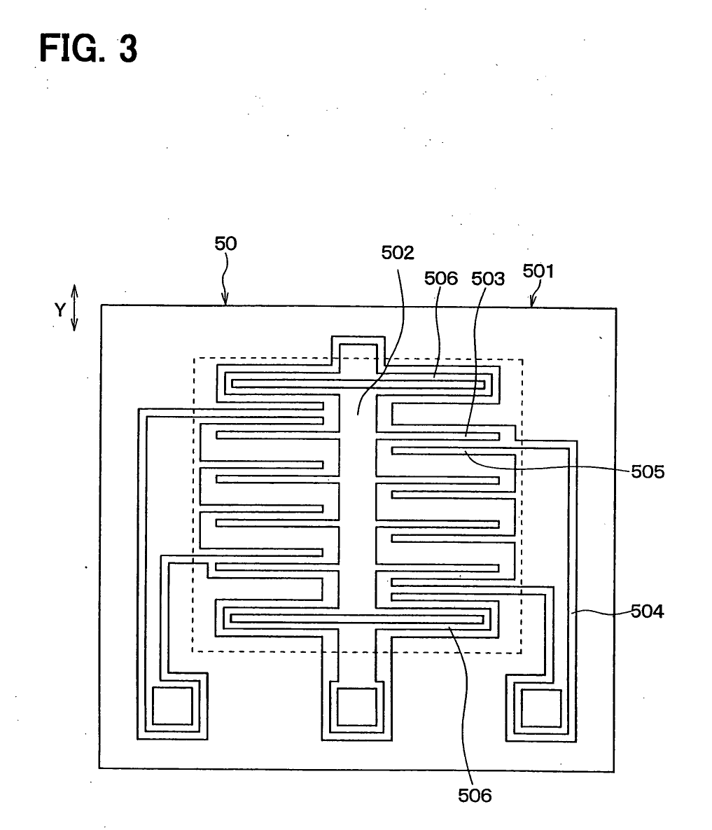

Next, the second acceleration sensor 50 is described with reference to FIG. 3. The acceleration sensor 50 is formed from a semiconductor substrate 501. The substrate 501 is etched so that a groove 504, a movable portion 502 having a movable electrode 503, and a fixed electrode 505 are formed. The movable electrode 503 and the fixed electrode 505 have comb-teeth portions, respectively. The movable electrode 503 is displaced in accordance with an acceleration applied to the second acceleration sensor 50. The fixed electrode 505 faces the movable electrode 503 in such a manner that each comb-teeth portion of the fixed electrode 505 and the movable electrode 503 is engaged together. Thus, a detection surface of one comb-tooth of the fixed electrode 505 faces a corresponding detection surface of one comb-tooth of the movable electrode 503 so that a capacitor therebetween is provided.

The movable electrode 503 is supported on the semiconductor substrate 501 as a support substrate through a spring 506. Therefore, the movable electrode 503 is movable in the Y direction. When the acceleration in the Y direction is applied to the second accelerations sensor 50, the movable electrode 503 is displaced in the Y direction. A distance between the detection surface of the movable electrode 503 and the detection surface of the fixed electrode 505 is changed in accordance with the displacement of the movable electrode 503 so that a capacitance of the capacitor between the movable electrode 503 and the fixed electrode 505 is changed. The capacitance change of the capacitor is detected so that the acceleration is detected.

In the physical quantity sensor shown in FIG. 1, three angular speed sensors 10, 20, 30 and three acceleration sensors 40, 50, 60 are mounted on the mounting base 1. The X axis, the Y axis and the Z axis components of the angular speed are detected by the first, the second and the third angular speed sensors 10, 20, 30, respectively. The X axis, the Y axis and the Z axis components of the acceleration are detected by the first, the second and the third acceleration sensors 40, 50, 60, respectively. Thus, the physical quantity sensor can detect both of the angular speed and the acceleration three dimensionally with high accuracy.

When the physical quantity sensor is used for controlling the attitude of the vehicle, it is required to detect the angular speed and the acceleration of the vehicle at a center of mass of the vehicle to control the attitude of the vehicle with high accuracy. If the detection axis of each angular sensor 10, 20, 30 or the detection axis of each acceleration sensor 40, 50, 60 is shifted from the center of mass of the vehicle, the acceleration or the angular speed is detected at a position deviated from the center of mass; and therefore, the detection accuracy is reduced. However, in the physical quantity sensor according to the first embodiment, three detection axes of the first, the second and the third angular speed sensors 10, 20, 30 intersect at one point so that the detection accuracy of the angular speed is improved. Further, three detection axes of the first, the second and the third acceleration sensors 40, 50, 60 intersect at one point so that the detection accuracy of the acceleration is improved. Thus, the detection accuracy of both of the angular speed and the acceleration is improved.

Although the angular speed sensor 10, 20, 30 and the acceleration sensor 40, 50, 60 have the above constructions, the angular speed sensor 10, 20, 30 and the acceleration sensor 40, 50, 60 can have other constructions as long as the angular speed sensor 10, 20, 30 can detect the angular speed around one axis and the acceleration sensor 40, 50, 60 can detect the acceleration in one direction.

(Second Embodiment)

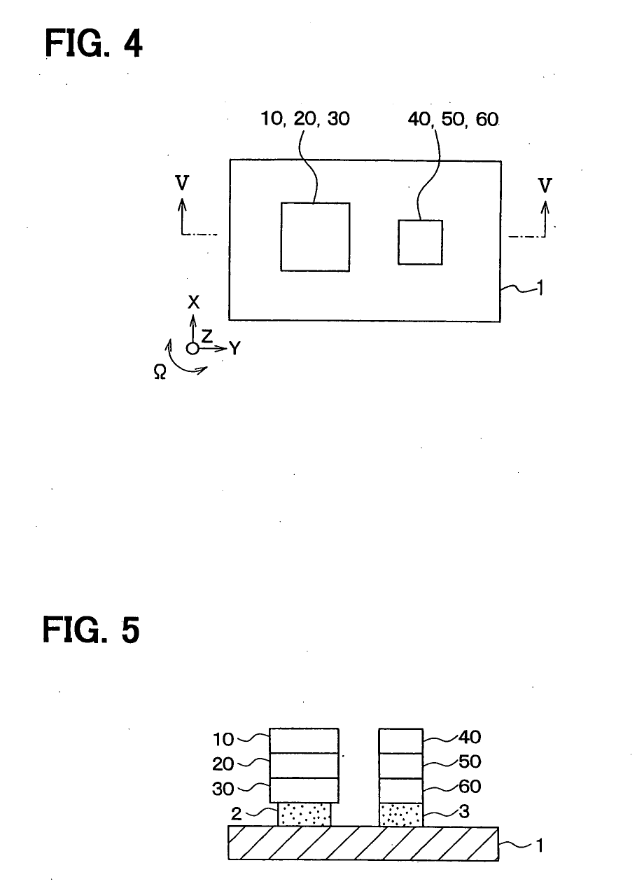

A physical quantity sensor according to a second embodiment of the present invention is shown in FIGS. 4 and 5. In the physical quantity sensor, three angular speed sensors 10, 20, 30 are laminated on the mounting base 1 at a predetermined position, and three sensors 40, 50, 60 are laminated on the mounting base 1 at another predetermined position.

Specifically, the first angular speed sensor 10, the second angular speed sensor 20 and the third angular speed sensor 30 are disposed on the mounting base 1 in this order. Similarly, the first acceleration sensor 40, the second acceleration sensor 50 and the third acceleration sensor 60 are disposed on the mounting base 1 in this order.

The third angular speed sensor 30 is bonded to the mounting base 1 with an adhesive 3, and the third acceleration sensor 60 is bonded to the mounting base 1 with another adhesive 4. The first, the second and the third angular speed sensors 10, 20, 30 are connected together with a bump (not shown), and the first, the second and the third acceleration sensors 40, 50, 60 are connected together with another bump (not shown). Although each sensors 10, 20, 30, 40, 50, 60 are bonded with the bump, the sensors 10, 20, 30, 40, 50, 60 can be bonded with a bonding wire. In this case, for example, a sensor 10, 20, 40, 50 disposed upper side becomes smaller than another sensor 20, 30, 50, 60 disposed lower side so that the upper sensor 10, 20, 40, 50 and the lower sensor 20, 30, 50, 60 are bonded with the wire bonding electrically. Further, a wiring penetrating the first to the third sensors 10, 20, 30, 40, 50, 60 in the vertical direction can provide an electric connection among the first to the third sensors 10, 20, 30, 40, 50, 60.

Thus, three angular speed sensors 10, 20, 30 are laminated so that they are approximated as short as possible. Therefore, the detection positions of the X component, the Y component and the Z component of the angular speed approach closer as close as possible. Accordingly, the detection accuracy of the angular speed is improved.

Three acceleration sensors 40, 50, 60 are laminated so that they are approximated as short as possible. Therefore, the detection positions of the X component, the Y component and the Z component of the acceleration approach closer as close as possible. Accordingly, the detection accuracy of the acceleration is improved.

Although the angular speed sensors 10, 20, 30 and the acceleration sensor 40, 50, 60 are laminated independently, the angular speed sensors 10, 20, 30 and the acceleration sensor 40, 50, 60 can be laminated on the mounting base 1 at the same point.

Such changes and modifications are to be understood as being within the scope of the present invention as defined by the appended claims.

1. A physical quantity sensor comprising:
a substrate;
three angular speed sensors disposed on the substrate; and
three acceleration sensors disposed on the substrate, wherein
the three angular speed sensors are capable of detecting three components of an angular speed around three axes, each two of which intersect perpendicularly,
the three acceleration sensors are capable of detecting three components of an acceleration in another three axes, each two of which intersect perpendicularly,
the three axes of the angular speed sensors intersect at one point, and
the other three axes of the acceleration sensors intersect at another one point.

2. The sensor according to claim 1, wherein
the three angular speed sensors are laminated on the substrate at a predetermined position, and
the three acceleration sensors are laminated on the substrate at another predetermined position.

3. The sensor according to claim 1, wherein
the three angular speed sensors and the three acceleration sensors are laminated on the substrate at a predetermined position.

4. The sensor according to claim 1, wherein
the angular speed sensor is a capacitance type angular speed sensor, and
the acceleration sensor is a capacitance type acceleration sensor.
